(19) United States
(12) Patent Application Publication
(10) Pub. No.: US 2015/0149275 A1
(43) Pub. Date: May 28, 2015

(54) QUASI-PROPORTIONAL ALLOCATION OF COMBINATION ITEMS FOR SERVING IN AN ONLINE AUCTION-BASED MARKETPLACE

(71) Applicant: Yahoo! Inc., Sunnyvale, CA (US)

(72) Inventors: Eric Bax, Sierra Madre, CA (US); Raghavendra Donamukkala, Valencia, CA (US); Rohit Chandra, Los Altos, CA (US); Abhay Kumar Gupta, Los Altos, CA (US)

(73) Assignee: Yahoo! Inc., Sunnyvale, CA (US)

(21) Appl. No.: 14/088,802

(22) Filed: Nov. 25, 2013

(51) Int. Cl. G06Q 30/02

(52) U.S. Cl. CPC G06Q 30/0275; G06Q 30/0277; G06Q 30/0246; G06Q 30/0283
USPC 705/14.45; 705/14.71

(57) ABSTRACT

Methods and systems are provided that can include value-based quasi-proportional allocation of combinations of online content items, such as online advertisements, for potential serving on Web pages. Combinations may be assembled and valued. A highest valued or otherwise qualified subset of combinations may be identified for serving. Combinations of the highest valued subset may be allocated for serving, and served, in accordance with a value-based quasi-proportional allocation scheme.

### BACKGROUND

In some online advertising marketplaces (including marketplaces for online and non-online content items, advertisements, etc.), publishers (which can include their representatives, agents or other proxies) may sell opportunities to advertise, and advertisers (which can include their representatives, agents or other proxies) may buy those opportunities in order to display their ads. For example, an online advertising marketplace may receive notices of opportunities to advertise from publishers, and may allocate opportunities among advertisers, and advertisements, based on factors including advertiser offers. An advertiser offer may include, for example, among other things, a bid price and an ad creative for display. The bid may include a price the advertiser is willing to pay for the ad to be served or displayed, or payment may be contingent on a user clicking on the ad or performing some follow-on action, such as a purchase, for example.

### BRIEF DESCRIPTION OF THE DRAWINGS

FIG. 1 illustrates a block diagram of a distributed computer system that can implement one or more aspects of a quasi-proportional allocation system or method according to one embodiment of the invention;

FIG. 2 illustrates a block diagram of an electronic device that can implement one or more aspects of a quasi-proportional allocation system or method according to one embodiment of the invention;

FIG. 3 illustrates a block diagram of a system that can implement one or more aspects of a quasi-proportional allocation system or method according to one embodiment of the invention;

FIGS. 4-7 illustrate flow diagrams of example operations of one or more aspects of a quasi-proportional allocation system or method according to one embodiment of the invention; and

FIG. 8 illustrates logic that may be used to implement one or more aspects of a quasi-proportional allocation system or method according to one embodiment of the invention.

While the invention is described with reference to the above drawings, the drawings are intended to be illustrative, and the invention contemplates other embodiments within the spirit of the invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.”

It is noted that description herein is not intended as an extensive overview, and as such, concepts may be simplified in the interests of clarity and brevity.

Some embodiments of the invention provide methods and systems that can include value-based quasi-proportional allocation of combinations of online content items, such as online advertisements, for serving on Web pages. Combinations may be assembled and valued. A highest valued or otherwise qualified subset of combinations may be identified for serving. Combinations of the highest valued subset may be allocated for serving, and served, in accordance with a value-based quasi-proportional allocation scheme.

Some embodiments of the invention include value-based quasi-proportional allocation of combinations of content items (which can include any content-including items), such as online advertisements (where an advertisement can include a specific advertisement, or an advertisement of a specified group, set or type), for serving in connection with serving opportunities (which can include actual serving opportunities; forecasted, predicted, assessed, theoretical, planned or anticipated serving opportunities; equivalent serving opportunities, etc.), although some embodiments may instead or additionally include proportional or other types of allocations. As exemplified and described further herein, quasi-proportional allocation, relative to value, can include any allocation of items, that can be indicated, described or defined by some function of the value for each item (potentially as well as one or more other variables), other than proportional allocation (exactly or linearly proportional) according to value.

In some embodiments, while advertiser bids are obtained in connection with allocation and serving of particular ads, combinations including multiple ads are then assembled, where the combinations may be treated in some ways as discrete units or offers.

In some embodiments, quasi-proportional allocation is performed of such combinations, according to value and utilizing, perhaps among other factors, advertiser bids associated with constituent ads. In some embodiments, quasi-proportional allocation can be used, for example, to spread out serving of combinations in certain proportions (by random specific allocation or otherwise) over many combination serving opportunities. Because combinations may be valued in part based on bids on particular ads of the combination, advertisers can tend to increase the value of a combination including their ad by increasing the bid associated with their ad, for example.

Value-based quasi-proportional allocation may then be used to allocate combinations, in any of various ways. In some embodiments, quasi-proportional allocation may be used in determining percentages, or proportions, fractions, probabilities, etc., of serving, or number of times or fraction of serving, of particular combinations across a large number of combination serving opportunities. Alternatively, or in addition, in some embodiments, combination serving opportunities may themselves be valued (whether in terms of value to marketmaker, value to advertisers in terms of predicted performance, relative likelihood of click of conversion, etc.), and allocation may be at least in part in accordance with this, such as by allocating higher valued combinations in greater proportion to higher value combination serving opportunities. Still further, in some embodiments, combination serving opportunities may themselves be ranked or grouped according to value or value range, and allocation may be in connection with such ranking or grouping, or partly so. As described further herein, in some embodiments, only qualified combinations, higher valued combinations, highest valued combinations, or combinations that have a value at or above a specified or reserve value, rank, etc., may be subject to allocation and served.

For example, the quasi-proportional allocation scheme may, in some embodiments, utilize a spreading type of approach, which can allow non-top value combinations to be served, or some number of them, as well as top-valued (or most desirable, to advertiser or other entities, or some combination) opportunities, while yet providing greater levels of serving, or higher-valued serving, to higher-valued combinations. For example, in some embodiments, combination serving opportunities themselves may be valued, or valued, grouped and ranked according to value, or a non-ranked value-based approach can be used, and quasi-proportional allocation may be used for spreading combinations, such as according to value. In some embodiments, for example, an advertiser, by bidding higher for a particular bid and specified ad, can increase or better the probability, proportion or amount of times that a combination including the ad, or including the ad in a certain ad slot, is served.

Furthermore, in some embodiments, quasi-proportional allocation allows a smooth, or relatively smooth, response, instead of an abrupt response if a value reaches a certain level and no response until the value reaches the next level. This can encourage more buyer participation due to bidding behavior yielding more predictable results and encourage more granular bid adjustment according to true advertiser value, even though, in some embodiments, combinations, and not bids on individual ads, may ultimately be treated as units and allocated.

Still further, depending on a function that may be used or could be used to describe a quasi-proportional allocation scheme, an entity such as the marketmaker, for instance, can exercise some control, throttling, or balancing of, on the one hand, bidding competition for ads to be included in combinations that are served, served more often, served in response to better serving opportunities, to be in higher ad slots within served combinations, etc., with, on the other hand, encouragement and reward for lower bidders, who may still see some proportion of such inclusion, or may see such inclusion if combinations including the ad are high enough valued or otherwise qualify for allocation and serving in some proportion.

For example, a function that leads to allocation according to the cube of a combination value may emphasize competition for a top-valued combination, or inclusion therein, relative to a function that leads to allocation according to the square of value, since a function that allocates according to the cube may provide more reward for higher valued combinations. Conversely, a function that allocates according to the square (or less) of combination value may provide more incentive for lower bidders, since they may effectively receive relatively more reward in that instance, since lower valued combinations, if at least sufficiently valued or qualified, may see more inclusion.

For illustration and in a simplified example, of many possible examples, a function that produces an allocation that is proportional to value might operate as follows. Suppose that combination A is valued at 10, and combination B at 5. Proportional allocation by number of times served could mean that combination A is served twice as many times as combination B (a 2:1 ratio). A quasi-proportional allocation that varies with the square of value might, on the other hand, for example, produce an allocation of 100 times serving combination A (10 squared) for each 25 times serving combination A(5 squared), a 4:1 ratio). Similarly, a function that produces output that varies with the cube of value might lead to an allocation of 1000 times serving combination A (10 cubed) per each 125 times serving combination B (5 cubed), which is a 100:12.5, or 8:1 ratio. As can be seen in this simplified example, different quasi-proportional allocation schemes and functions can lead to different amount of reward for top-valued combinations (and high bids for constituent ads may, in some embodiments, help lead to high-valued combinations), and different amount of reward for lower-valued combinations. For example, a cube-based function may shift reward more in favor of the higher valued combination, combination A (an 8:1 ratio) relative to a square-based function (a 4:1 ratio).

In some embodiments, valuation of ad combinations may take into account assessed effects of one or more ads in combination with one or more other ads, thus allowing a valuation of the ad combination as a whole, taking into account such effects. For example, some pairs (or groups) of ads, such as, as possible examples, complimentary ads for similar products, products that work together, appeal to similar demographics, etc., may have a synergistic effect on each other. Other ads may have the opposite effect on each other, and effectively de-value each other, or one may de-value the other, etc. Such effects may be assessed (or predicted, estimated, etc.) and taken into account in valuing combinations. For example, historical performance information may be utilized and analyzed in this regard, whether of individual ads or combinations, and one or more feature-based machine learning models may also be utilized in the assessments. Of course, many other factors can be taken into account in assembling and valuing combinations, including advertiser targeting or other preferences, available or anticipated serving opportunities or parameters thereof, etc.

In some embodiments, advertisers may be made aware of the allocation scheme, or at least some elements thereof, such as by being informed of the use of combinations, use of a quasi-proportional allocation scheme, use of a particular function for allocation, etc. In some embodiments, advertisers may be made aware of all elements, even including an allocation function, or may be made only partly aware or aware at some broad level, or not.

The spreading aspect of quasi-proportional allocation, according to some embodiments, encourages competition not only for top valued combinations, or inclusion therein, since all opportunities are not simply allocated to a single highest value or “winning” combination.

In some embodiments, quasi-proportional allocation may be based on a value (which can be or include an offer value) associated with each of multiple combinations of advertisements. The value may be based on or defined in any of numerous ways. In some embodiments, the value may be in connection with, or to, a marketmaker (which can include, for example, any entity that engages in or facilitates administration, management, implementation or operation of a market). For example, in some embodiments, the value may be a value to a marketmaker in connection with, based on, or partly based on, actual, anticipated, assessed, predicted, forecasted or estimated revenue, profit or other benefit to the marketmaker. For example, in some embodiments, a value may be based on a forecasted profit to the marketmaker as a result of serving of the combination in accordance with the allocation. Of course, in some embodiments, any of numerous other types of values can be utilized, such as values that includes factors relating to value to other entities, such as an advertiser, publisher or data provider. Furthermore, value may be based at least in part on other types of factors entirely, such as quality-based factors, factors relating to marketplace shaping or optimization, throttling, controlling or balancing competition for advertisement slots, etc.

Quasi-proportional allocation of combinations can be used, in some embodiments, among other things, as a factor in controlling, throttling or balancing competition or inclusiveness, among advertisers, such as, for example, in controlling relative level of competition or reward for being included in one or more top or higher valued combinations, or in better advertising slots of combinations, or controlling relative competition or reward for being included in lower-valued combinations or slots therein (for combinations in which slots are ordered or ranked). Furthermore, in some embodiments, quasi-proportional allocation can allow, among other things, for relatively smooth response or reward to advertisers, in connection with increasing or decreasing bids.

While described largely in connection with online advertising such as display advertising, some embodiments of the invention are used, or also used, in search advertising, or sponsored search, for example, as well as other contexts, such as information-providing, content-providing, and advertising contexts.

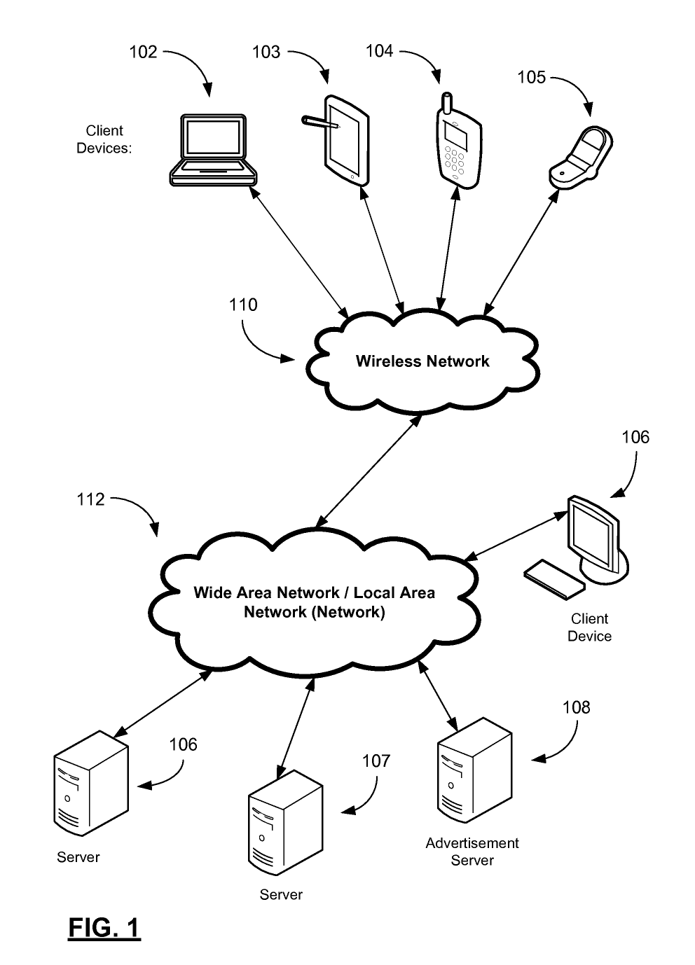

FIG. 1 illustrates components of one embodiment of an environment in which a quasi-proportional allocation system, according to some embodiments of the invention, may be practiced. Not all of the components may be required to practice the invention, and variations in the arrangement and type of the components may be made without departing from the spirit or scope of the invention. As shown, the system 100 includes one or more local area networks (“LANs”)/wide area networks (“WANs”) 112, one or more wireless networks 110, one or more wired or wireless client devices 106, mobile or other wireless client devices 102-105, servers 106-107 and one or more advertisement servers 108, and may include or communicate with one or more data stores or databases. Various of the client devices 102-106 may include, for example, desktop computers, laptop computers, set top boxes, tablets, cell phones, smart phones, etc. The servers 106-107 can include, for example, one or more application servers, content servers, search servers, etc.

The system 100 also includes one or more advertisement servers 108. An advertisement server can include, for example, a computer server that has a role in connection with online advertising, such as, for example, in obtaining, storing, determining, configuring, selecting, ranking, retrieving, targeting, matching, serving and presenting online advertisements to users, such as on websites, in applications, and other places where users will see them.

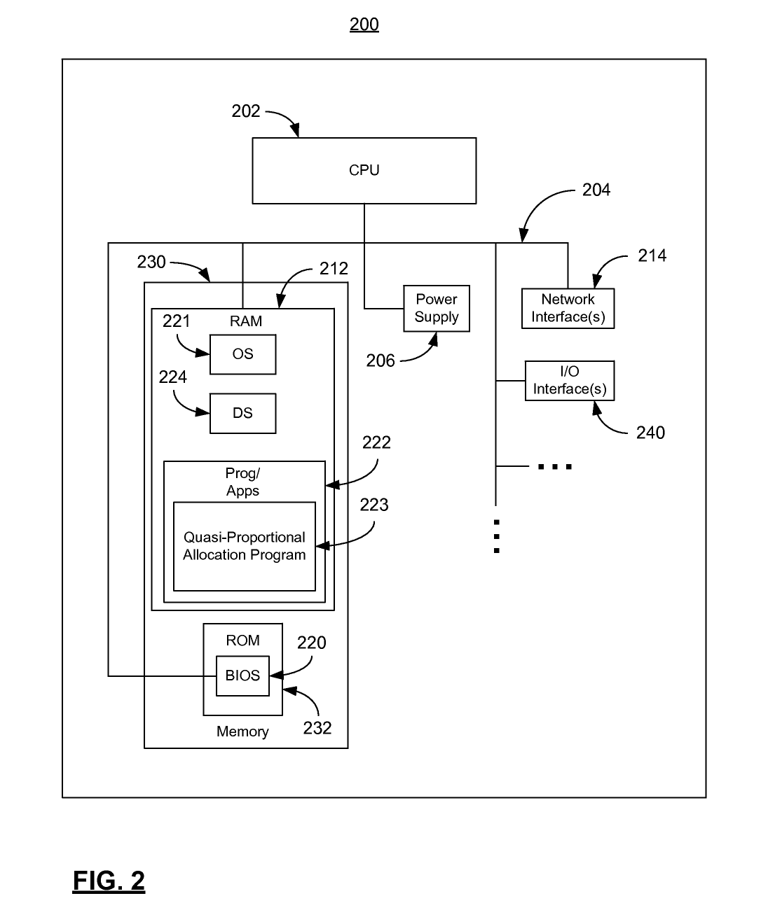

Elements of the system 100, which may include the servers 106-108 may include a Quasi-Proportional Allocation Program, as depicted, for example, in FIG. 2.

FIG. 2 illustrates a block diagram of an electronic device 200 that can implement one or more aspects of Quasi-Proportional Allocation Program 223, according to one embodiment of the invention. Instances of the electronic device 200 may include servers, e.g. servers 106-108, and client devices, e.g. client devices 102-106. In general, the electronic device 200 can include a processor 202, memory 230, a power supply 206, and input/output (I/O) components 240, e.g., microphones, speakers, displays, touchscreens, keyboards, keypads, GPS components, etc., which may be operable, for example, to provide graphical user interfaces. The electronic device 200 can also include a communications bus 204 that connects the aforementioned elements of the electronic device 200. Network interfaces 214 can include a receiver and a transmitter (or transceiver), and an antenna for wireless communications.

The processor 202 can include one or more of any type of processing device, e.g., a central processing unit (CPU). Also, for example, the processor can be central processing logic. Central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software controlled microprocessor, discrete logic, e.g., an application specific integrated circuit (ASIC), a programmable/programmed logic device, memory device containing instructions, etc., or combinatorial logic embodied in hardware. Furthermore, logic may also be fully embodied as software. The memory 230, which can include RAM 212 and ROM 232, can be enabled by one or more of any type of memory device, e.g., a primary (directly accessible by the CPU) or secondary (indirectly accessible by the CPU) storage device (e.g., flash memory, magnetic disk, optical disk). The ROM 232 can also include BIOS 220 of the electronic device.

The RAM can include an operating system 221, data storage 224, which may include one or more databases, and, among other things, programs or applications 222, which can include, for example, a Quasi-Proportional allocation Program 223. The Program 223 is intended to broadly include or represent all programming, applications, algorithms, software and other tools necessary to implement or facilitate methods and systems according to embodiments of the invention. The elements of the Quasi-Proportional Allocation Program 223 may exist on a single server computer or be distributed among multiple computers or devices or entities, which can include advertisers, publishers, data providers, etc.

The power supply 206 contains one or more power components, and facilitates supply and management of power to the electronic device 200.

The input/output components, including I/O interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, and one or more input/output interfaces. A network care, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Quasi-Proportional Allocation Program 223, via a network to another device. Also, an application server may, for example, host a Web site that can provide a user interface for administration of example aspects of the Quasi-Proportional Allocation Program 223.

Any computing device capable of sending, receiving, and processing data over a wired and/or a wireless network may act as a server, such as in facilitating aspects of implementations of the. Thus, devices acting as a server may include devices such as dedicated rack-mounted servers, desktop computers, laptop computers, set top boxes, integrated devices combining one or more of the preceding devices, etc.

Servers may vary in widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, etc.

A server may include, for example, a device that is configured, or includes a configuration, to provide data or content via one or more networks to another device, such as in facilitating aspects of an example Quasi-Proportional Allocation Program 223. One or more servers may, for example, be used in hosting a Web site, such as the Yahoo! Web site. One or more servers may host a variety of sites, such as, for example, business sites, informational sites, social networking sites, educational sites, wikis, financial sites, government sites, personal sites, etc.

Servers may also, for example, provide a variety of services, such as Web services, third-party services, audio services, video services, email services, instant messaging (IM) services, SMS services, MMS services, FTP services, voice or IP (VOIP) services, calendaring services, phone services, advertising services etc., all of which may work in conjunction with example aspects of an example Quasi-Proportional Allocation Program 223. Content may include, for example, text, images, audio, video, advertisements, etc.

In example aspects of the Quasi-Proportional Allocation Program 223, client devices may include, for example, any computing device capable of sending and receiving data over a wired and/or a wireless network. Such client devices may include desktop computers as well as portable devices such as cellular telephones, smart phones, display pagers, radio frequency (RF) devices, infrared (IR) devices, Personal Digital Assistants (PDAs), handheld computers, GPS-enabled devices tablet computers, sensor-equipped devices, laptop computers, set top boxes, wearable computers, integrated devices combining one or more of the preceding devices, etc.

Client devices, as may be used in an example Quasi-Proportional Allocation Program 223, may range widely in terms of capabilities and features. For example, a cell phone, smart phone or tablet may have a numeric keypad and a few lines of monochrome LCD display on which only text may be displayed. In another example, a Web-enabled client device may have a physical or virtual keyboard, data storage (such as flash memory or SD cards), accelerometers, gyroscopes, GPS or other location-aware capability, and a 2D or 3D touch-sensitive color screen on which both text and graphics may be displayed.

Client devices, such as client devices 102-106, for example, as may be used in an example Quasi-Proportional Allocation Program 223, may run a variety of operating systems, including personal computer operating systems such as Windows, iOS or Linux, and mobile operating systems such as iOS, Android, and Windows Mobile, etc. Client devices may be used to run one or more applications that are configured to send or receive data from another computing device. Client applications may provide and receive textual content, multimedia information, etc. Client applications may perform actions such as browsing webpages, using a web search engine, sending and receiving messages via email, SMS, or MMS, playing games (such as fantasy sports leagues), receiving advertising, watching locally stored or streamed video, or participating in social networks.

In example aspects of a Quasi-Proportional Allocation Program 223, one or more networks, such as networks 110 or 112, for example, may couple servers and client devices with other computing devices, including through wireless network to client devices. A network may be enabled to employ any form of computer readable media for communicating information from one electronic device to another. A network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and a telephone link.

A wireless network, such as wireless network 110, as in an example Quasi-Proportional Allocation Program 223, may couple devices with a network. A wireless network may employ stand-alone ad-hoc networks, mesh networks, Wireless LAN (WLAN) networks, cellular networks, etc.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, etc. Access technologies such as 2G, 2.5G, 3G, 4G, and future access networks may enable wide area coverage for client devices, such as client devices with various degrees of mobility. For example, wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, etc. A wireless network may include virtually any wireless communication mechanism by which information may travel between client devices and another computing device, network, etc.

Internet Protocol may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), wide area networks (WANs), wireless networks, and long haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site

A “content delivery network” or “content distribution network” (CDN), as may be used in an example Quasi-Proportional Allocation Program 223, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's Web site infrastructure, in whole or in part, on the third party's behalf.

A peer-to-peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Some embodiments include direct or indirect use of social networks and social network information, such as in targeted advertising or advertisement selection. A “Social network” refers generally to a network of acquaintances, friends, family, colleagues, and/or coworkers, and potentially the subsequent connections within those networks. A social network, for example, may be utilized to find more relevant connections for a variety of activities, including, but not limited to, dating, job networking, receiving or providing service referrals, content sharing, creating new associations or maintaining existing associations with like-minded individuals, finding activity partners, performing or supporting commercial transactions, etc.

A social network may include individuals with similar experiences, opinions, education levels and/or backgrounds, or may be organized into subgroups according to user profile, where a member may belong to multiple subgroups. A user may have multiple “1:few” circles, such as their family, college classmates, or coworkers.

A person's online social network includes the person's set of direct relationships and/or indirect personal relationships. Direct personal relationships refers to relationships with people the user communicates with directly, which may include family members, friends, colleagues, coworkers, and the like. Indirect personal relationships refers to people with whom a person has not had some form of direct contact, such as a friend of a friend, or the like. Different privileges and permissions may be associated with those relationships. A social network may connect a person with other people or entities, such as companies, brands, or virtual persons. A person's connections on a social network may be represented visually by a “social graph” that represents each entity as a node and each relationship as an edge.

Users may interact with social networks through a variety of devices. Multi-modal communications technologies may enable consumers to engage in conversations across multiple devices and platforms, such as cell phones, smart phones, tablet computing devices, personal computers, televisions, SMS/MMS, email, instant messenger clients, forums, and social networking sites (such as Facebook, Twitter, and Google+), or others.

In some embodiments, an example Quasi-Proportional Allocation Program 223 can make use of various monetization techniques or models may be used in connection with contextual or non-search related advertising, as well as in sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some aspects of an example Quasi-Proportional Allocation Program 223 include advertising. Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

The process of buying and selling online advertisements may include or require the involvement of a number of different entities, including advertisers, publishers, agencies, networks, and developers. To simplify this process, some companies provide mutual organization systems called “ad exchanges” that connect advertisers and publishers in a unified platform to facilitate the bidded buying and selling of online advertisement inventory from multiple ad networks. “Ad networks” refers to companies that aggregate ad space supply from publishers and provide en masse to advertisers.

For Web portals, such as Yahoo!, advertisements may be displayed on web pages resulting from a user-defined search based upon one or more search terms. Such advertising is most beneficial to users, advertisers and web portals when the displayed advertisements are relevant to the web portal user's interests. Thus, a variety of techniques have been developed to infer the user's interests/intent and subsequently target the most relevant advertising to that user.

One approach to improving the effectiveness of presenting targeted advertisements to those users interested in receiving product information from various sellers is to employ demographic characteristics (i.e., age, income, sex, occupation, etc.) for predicting the behavior of groups of different users. Advertisements may be presented to each user in a targeted audience based upon predicted behaviors rather than in response to certain keyword search terms.

Another approach is profile-based ad targeting. In this approach, user profiles specific to each user are generated to model user behavior, for example, by tracking each user's path through a web site or network of sites, and then compiling a profile based on what pages and advertisements were delivered to the user. Using aggregated data, a correlation develops between users in a certain target audience and the products that those users purchase. The correlation then is used to target potential purchasers by targeting content or advertisements to the user at a later time.

During the presentation of advertisements, the presentation system may collect detailed information about the type of advertisements presented to the user. This information may be used for gathering analytic information on the advertising or potential advertising within the presentation. A broad range of analytic information may be gathered, including information specific to the advertising presentation system. Advertising analytics gathered may be transmitted to locations remote to the local advertising presentation system for storage or for further analysis. Where such advertising analytics transmittal is not immediately available, the gathered advertising analytics may be saved by the advertising presentation system until the transmittal of those advertising analytics becomes available.

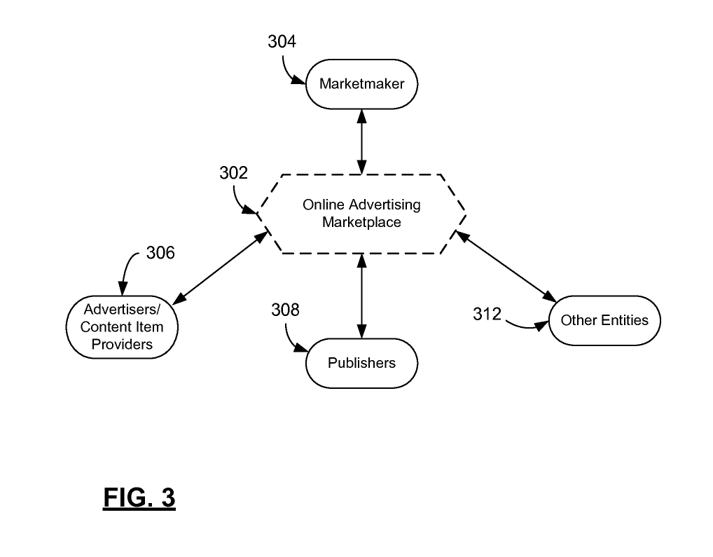

FIG. 3 illustrates an example distributed system 300 in which aspects of some embodiments of the invention can be practiced (although all elements of the system are not necessary in practicing various elements or embodiments of the invention). The system 300 includes a marketmaker 304 and an online advertising marketplace 302, which may, for example, be auction-based. Entities associated, directly or indirectly, with the marketplace 302 can include advertisers 306, publishers 308 and other entities 312, such as ad networks, data providers, partners, etc.

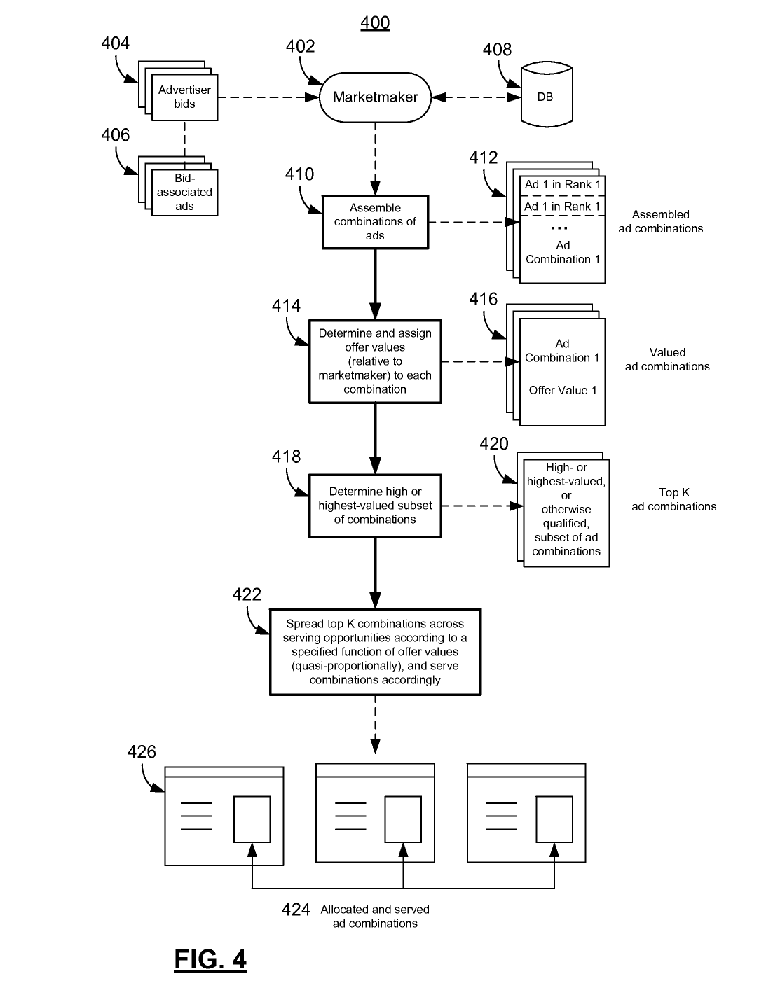

FIG. 4 illustrates a flow diagram 400 of example operations of one or more aspects of a quasi-proportional allocation system or method according to one embodiment of the invention. The method 400 may be implemented or partially implemented by marketmaker 402 including use of one or more data stores or databases 408, and one or more server computers, such as depicted in FIG. 1.

As depicted, block 404 represents advertiser bids and block 406 represents specified bid-associated advertisements, information about which is obtained or received by the marketmaker 402 (whether directly or through one or more intermediaries).

Block 410 represents assembly of combinations of ads, such as ads specified in association with advertiser bids. In some embodiments, the assembly may be accomplished, in whole or in part, by the marketmaker 402. A simplified example of such a combination is depicted at block 412. As depicted, each combination may include multiple ads (or types of ads, etc.) at each of multiple ad slots or positions. Higher ranked or top slots may be more valuable. Although for simplicity depicted as a unified, rectangular shape, it is to be understood that a combination may be of any shape, or include multiple areas, and may include ad slots and ads of different shapes, may include multiple different separate areas or shapes on a page, differently placed slots of differing value, etc. Of course, many other complexities are possible and contemplated.

In some embodiments, the combination 412 may be a complete and ordered slate of ads. However, in some embodiments, combinations may not be ordered, such that ads that compose the combination may appear in any slot of the combination. For example, a slate of ads may be a group of ads for serving together, such as upon or with loading of a Web page, which ads may be included on or added onto the Web page, although serving other than to or on Web pages is also contemplated, as is serving other than over the Internet, and serving to various mobile devices, etc.

Block 414 represents the marketmaker, for example, determining (or calculating, etc.) an offer value for each of the combinations 416. An offer value, or value, may, in some embodiments, be a determined value to the marketmaker of the particular combination or offered combination, or in whole or in part may be other than relative to the marketmaker.

In some embodiments, the value to the marketmaker may only be a factor in determining the value, or may not be a factor at all. In some embodiments, the value may be in connection with one or more other entities, such as one or more advertisers, publishers, users, etc. In some embodiments, the offer value may be an assessed, predicted or forecasted value based at least in part on forecasted profit to the marketmaker in connection with serving of the combination (perhaps many times over a period, etc.). In some embodiments, one or more functions, equations, variables, etc., such as may include advertiser or advertisement quality, etc., may be used in determining values or offer values.

At block 418, a high or highest valued, or qualified or otherwise qualified, subset 420 of the combinations is determined, or “top K” combinations, where K is the number of combinations in the subset. These could be the combinations (or combinatinos of a certain group of combinations) with higher or the highest determined value, or could be qualified in some other way, or in a combination of ways. For instance, in some embodiments, qualified combinations may be combinations that, as at least one factor, meet a set reserve price or value requirement.

Block 422 represents allocation, or spreading, of the top K combinations (for serving possibly many times each, among a large group of serving opportunities or over a period of time) according to, or partly according to, a specified function of offer values (quasi-proportionally), and serving of the combinations accordingly. In some embodiments, for example, a greater number of higher-valued combinations may be served, or a higher proportion of higher-valued combinations may be served to higher-valued combination serving opportunities, etc.

Block 424 represents allocation and serving of combinations to Web pages 426. In embodiments, performance of combinations following serving is tracked, and the tracked and stored performance information may be analyzed and used as feedback in future allocations. In some embodiments, one or more machine learning techniques, such as feature-based and matrix-based machine learning techniques, may be utilized in determining or optimizing allocation, and in utilized feedback information for optimization, further optimization, or iterative optimization.

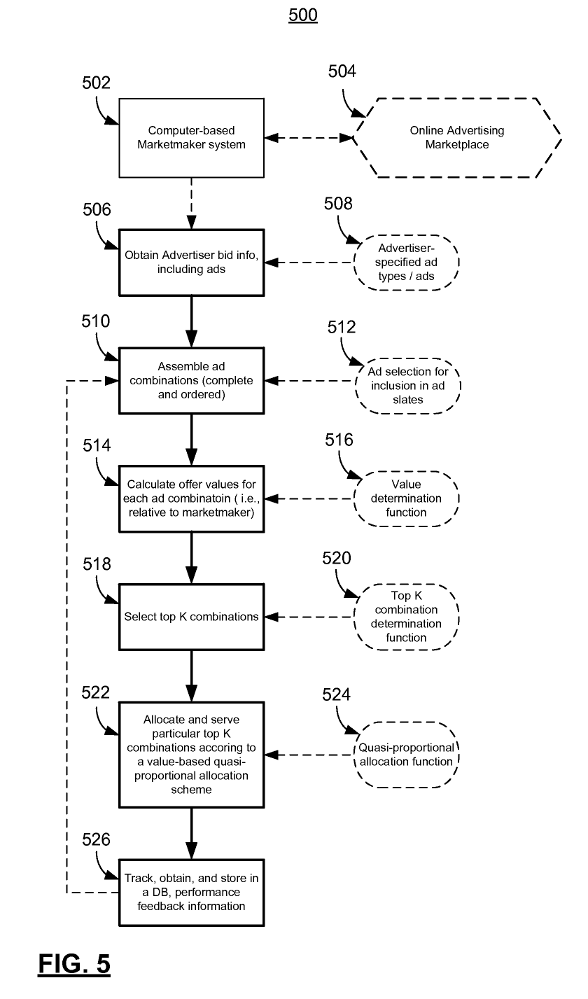

FIG. 5 illustrates a flow diagram of example operations of one or more aspects of a quasi-proportional allocation system or method according to one embodiment of the invention. Method 500 begins with step 506, at which a computer-based marketmaker system 502, which administers (including partly administering or facilitating administration of) an online advertising marketplace 504, obtains advertiser bids, including specified ads 508 (or ad types, groups, parameters, etc.).

Step 510 includes assembly of ad combinations, including selection of ads 512, each of which combinations may be complete, for example, in the sense that it represents a complete set of ads for serving upon loading or rendering of a Web page (or a complete set of one type of ad, such as display ads or sponsored search ads, or a complete set of ads served together according to the quasi-proportional allocation scheme, or some other complete set of ads that may be a subset of all ads appearing on the page), and may be ordered in the sense that ads are assigned ad slots that may each represent a position or prominence of the ad in the set. Ad slots or positions may be ranked according to value. For example, more prominent positions, or positionally first or highest positions, may be considered most valuable, such as by being more likely to be noticed, selected, or receive other user actions, such as conversions, than other positions, though many other possibilities are contemplated. However, in some embodiments, combinations are treated and valued as units, so that quasi-proportional allocation is used directly in allocating combinations, not individual ads (although ads and bids associated with ads can potentially affect combination values, and thus affect allocation of combinations). Furthermore, in some embodiments, combinations do not include ranking of ads, and ads in a combination may appear in any slot.

Step 514 represents calculation of offer values associated with individual combinations (although in some embodiments, combinations may be grouped and valued as groups), which can include use of some valuation function 516, which may or may not include use of a function of one or more variables or values, which can include bids associated with ads, advertiser quality measures, ad quality measures, etc., in association with ads in the combination, and may also include one or more factors that account for assessed or predicted effects of one or more ads on one or more other ads in the combination, among other factors.

Step 518 represents selection of a top K ad combinations, which may or may not include of a top K combination determination function 520. In some embodiments, the top K combinations may be higher valued combinations, highest valued combinations, combinations that reach or exceed a certain threshold or reserve value, or some combinations of one or more of these factors as well as, or alternatively, possibly other factors.

Step 522 includes allocation and serving of particular top K combinations according to a value-based quasi-proportional allocation scheme, which may include, or otherwise be describable with, a quasi-proportional allocation function 524.

Step 526 includes tracking, obtaining, and storing in one or more data stores or data bases, such as using one or more servers, performance feedback information, such as in connection with performance of particular combinations, or such combinations in particular contexts, or certain ads of combinations, which can be used, among other things, in future allocations and allocation-related activities, such as in helping optimize such.

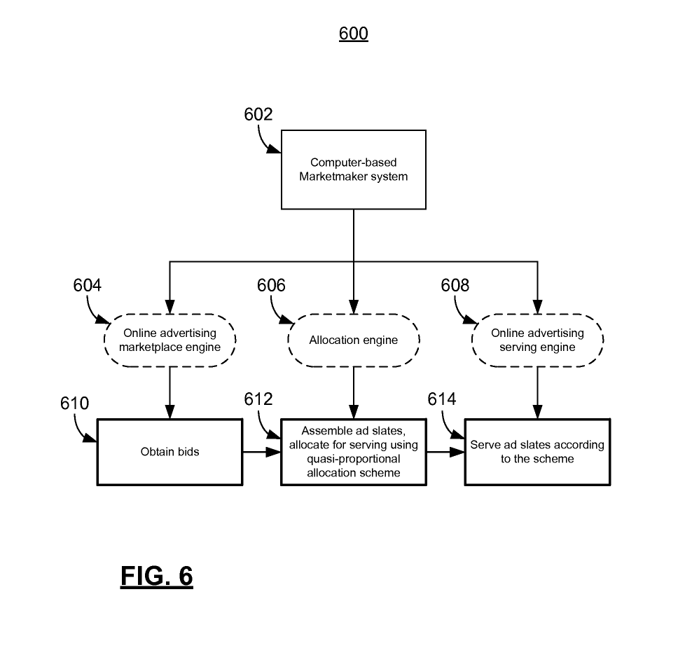

FIG. 6 illustrates a flow diagram of example operations of one or more aspects of a quasi-proportional allocation system or method according to one embodiment of the invention. Block 602 represents a computer-based marketmaker system, which may, in whole or in part, implement a quasi-proportional allocation program 223 and method 600. The system 602 includes or is used to implement several engines 604, 606, 608. The engines 604, 606, 608 may be, for example, program-based or software-based modules or conceptual units that may include programming, software, applications, etc., used in implementing or affecting aspects, functions or uses of some embodiments of the invention. Among other possibilities, the engines 604, 606, 608 may be included in or implemented using one or more servers of the system 602, including one or more processors and data stores or databases, or elements of the engines 604, 606, 608 may be distributed among different systems, which could include, for example, advertiser, publisher or other entity systems. In some embodiments, the various engines 604, 606, 608, perhaps along with one or more other engines or other elements, may work together or in coordination to practice or implement methods or techniques according to embodiments of the invention.

The engines 604, 606, 608 include an online advertising marketplace engine 604, that may be used for, among other things, as represented as step 610, in obtaining advertiser bids 610 or advertiser bid information, whether directly or through one or more intermediaries. The engines may also include an allocation engine 606, that may be used for, among other things, as represented as step 612, assembling and storing ad slates or combinations, and for allocating the ad slates for serving using a quasi-proportional allocation scheme. The engines may further include an online advertising serving engine 608, that may be used for, among other thing, as represented by step 614, serving or displaying ad slates according to the scheme.

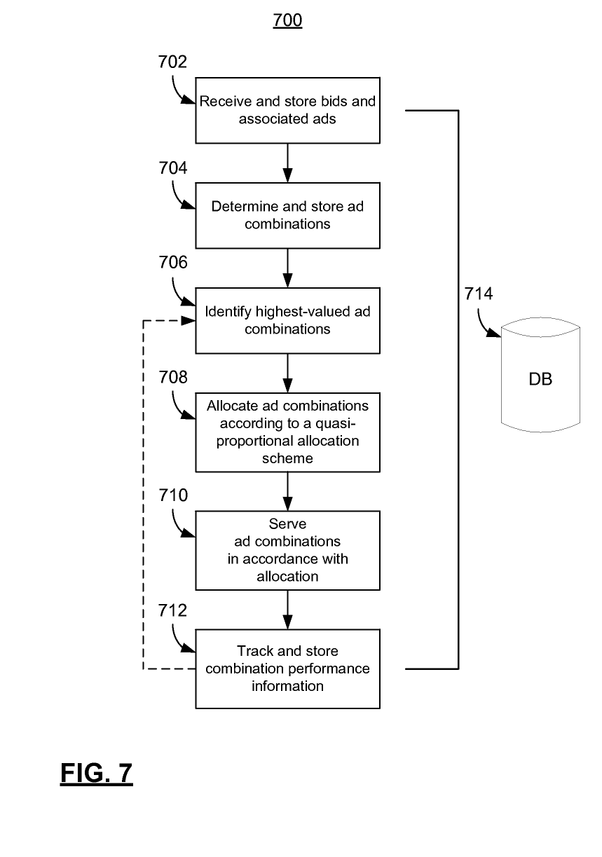

FIG. 7 illustrates a flow diagram of example operations of one or more aspects of a quasi-proportional allocation system or method according to one embodiment of the invention. Step 702 of the method 700 includes receiving and storing, in one or more data stores or databases, advertiser bids and associated specified ads. Step 704 includes, using the information obtained at step 702, determining and storing ad combinations. Step 706 includes identifying highest value combinations.

Subsequent to this, step 708 includes, using information obtained at step 706, allocating ad combinations across combination serving opportunities according to a quasi-proportional allocation scheme.

After such allocation has been determined, step 710 includes serving or displaying ad combinations in accordance with the allocation and scheme.

Subsequent to serving, step 712 represents tracking and storing ad combination performance information (such as associated user clicks, actions, conversions, etc.), such as in database 714. Tracked information may be used as feedback, for example, in optimizing future actions, such as by being used at step 706 and later steps, as may be used in future allocations and determinations.

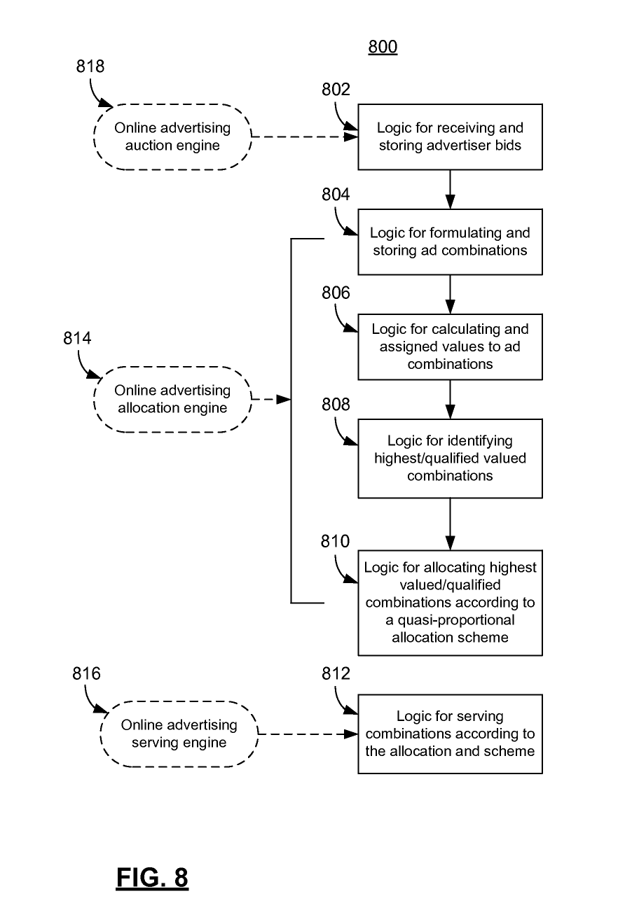

FIG. 8 illustrates logic 800, such as software or programming based logic, that may be used to implement one or more aspects of a quasi-proportional allocation system or method according to one embodiment of the invention, such as may be elements of one embodiment of a Quasi-Proportional Allocation Program 223. As depicted, an online advertising auction engine 818 or module may be used in providing logic for receiving and storing advertiser bids, or bid information 802.

Furthermore, an online advertising allocation engine 814 or module, may be used in providing various logic. The engine 814 may provide logic for formulating and storing ad combinations 804, for calculating and assigning values to ad combinations 806, and for identifying higher valued, highest valued, or qualified or otherwise qualified ad combinations 808. Further, the engine 814 may provide logic for allocating highest valued, qualified, or otherwise qualified ad combinations according to a specific quasi-proportional allocation scheme 810. In some embodiments, however, all combinations may be allocated, and no subset of higher, highest, or qualified combinations may need to be performed.

Still further, an online advertising serving engine 816 may be used in providing logic for serving combinations (online or otherwise) or displaying them according to the allocation and scheme 812.

It is observed that online content pages often include multiple ad (or other content or information) slots (which can include video slots, dynamic slots, etc), and the effectiveness and value of showing an ad in one slot may be affected by which ads are shown in the other slots. For example, with in-stream ads, if an ad shown in an early slot causes viewers to leave the page rather than scroll through more of the stream, then displaying that ad can cause a loss of the slots that can occur later in the stream. Similarly, if there are two slots on a static page, ads for similar products may both generate more user response when shown together than when shown with ads for different products. Some embodiments of the invention advantageously take into account such effects, and other effects, such as by use and valuation of ad combinations that takes into account ad-to-ad effects (which may be determined, estimated, predicted, etc.).

It is further observed that, in general, if an online marketplace uses a winner-take-all allocation in which the combination offering the highest combined value to the wins each combination serving opportunity (which may be a set of individual ad serving opportunities, or otherwise), advertisers with ads in combinations with lower values may be under-rewarded, and may abandon the marketplace, leaving less competition, which creates an incentive for the highest bidders to bid less over time. This can lead to a suboptimal marketplace and less revenue, for example, for the marketmaker. Conversely, if all bidders receive equal treatment, then bidders lack an incentive to bid in accordance with their valuations of the opportunities. Some embodiments of the invention allow more optimal or efficient balancing and controlling or throttling, of these opposing needs, by using quasi-proportional allocation.

Furthermore, in an allocation scheme in which all bidders receive some share of the ad calls regardless of their bids, there is an incentive for advertisers to lower their bids. Furthermore, since advertiser bids for specified ads ultimately effort allocation and serving of combinations including such ads, in some embodiments, it is advantageous to limit which combinations participate in each allocation, based on the combined values that combinations offer for publishers. For example, this can include allocating only highest valued combinations, higher valued combinations, combinations that meet or exceed a specified threshold or reserve value, or combinations that are qualified or otherwise qualified in these or other ways. However, embodiments are contemplated where no qualification is needed. Furthermore, embodiments are contemplated where advertisers actually bid on ad inclusion in combinations directly.

Various data, metadata, or parameters may be utilized or taken into account in connection with various items or elements used in or with embodiments of the invention. For example, opportunities to advertise, such as an entire ad combination, can include user data, content data, page ad slot data, and other data. Useful marketplace related data can include, for example, advertiser bids and associated data such as the bid amount, the bid price or pricing type or method (per impression, click, action, etc.), the ad creative, ad quality (such as may be assessed by past performance) and data about the advertiser itself, or quality thereof. Data associated with ad combination can include, among other things, data about each ad and creative in each ad slot, and associated bid data, price data for the ads, effects or estimated or predicted effects between ads on ad performance, etc. Furthermore, in addition to the various data mentioned above regarding combination valuation, other types of data may also be used, such as, for example, estimated or predicted impact on user experience, estimated or predicted user response probabilities, ad opportunity quality measures, etc. Accounting for estimated response probabilities can include, for example, prediction of click and action rates for ads within combinations, or can include estimated probabilities of some ads not being viewed because a user leaves the page before scrolling those ad slots into view, and many other possible factors. Accounting for ad impact on user experience can include, for example, accounting for estimated long-term revenue impact to the publisher from combinations either encouraging or discouraging users to visit the publisher's website(s) in the future, for example. Accounting for opportunity quality can include, for example, quality-based bidding, which can be similar to quality-based pricing, or QBP. For example, in some situations, the marketmaker or marketplace may use QBP post-selection adjustments if the advertisers all have the same price type and use the same quality adjustment, or otherwise may use pre-selection or bidding time adjustments.

Although described primarily with reference to combinations with set ads or ad types per slot, some embodiments encompass types or groups of combinations with certain parameters in common, such as combinations with a certain number of common ads, ads in each slot, similar values, etc., which groups may be treated similarly or as a unit in some ways. Furthermore, embodiments are contemplated not only of combinations with particular numbers of ads, but also of different combinations with different numbers of ads or ad slots.

Allocation, which may be based on output of a value-based quasi-proportional allocation function, can be implemented in any of various ways, which can include, for example, elements that include random allocation elements on a per-opportunity basis, fractional allocation elements, etc. In some embodiments, if no or insufficient numbers of combinations are sufficiently high-valued, qualified, or otherwise qualified for allocation and serving, backfill may be provided, such as using non-combinations or other ads, or combinations may be altered, deleted from or added to meet certain standards, allocation may be modified, etc.

Although described generally in connection with opportunities to serve combinations, embodiments are also contemplated that include serving of portions of combinations, or individual ads of combinations, and associated serving opportunities or sets of serving opportunities, that may be considered to satisfy or sufficiently satisfy an allocation scheme or modified allocation scheme, such as by leading to an appropriate amount or fraction of serving of particular subsets of combinations, or individuals ads of combinations.

While the systems and methods have been described in terms of one or more embodiments, it is to be understood that the disclosure need not be limited to the disclosed embodiments. It is intended to cover various modifications and similar arrangements included within the scope of the claims, the scope of which should be accorded the broadest interpretations so as to encompass all such modifications and similar structures.

1. A system comprising:
A computer-based system, comprising one or more server computers, each of the server computers comprising a processor and a memory, for use in administering an auction-based content item marketplace operated by a marketplace provider, wherein the computer-based system is configured to:
obtain bid information including bids of each of a plurality of content providers for serving of specified content items to users on Web pages;
assemble a plurality of combinations of subsets of the specified content items, wherein each of the combinations represents an ordered set of content items for potential serving on a Web page;
determine and attribute, to each of the combinations, an offer value representing a value of the combination to the marketplace provider;
select a highest valued subset of the combinations for serving in response to combination serving opportunities; and
serve combinations of the subset in response to combination serving opportunities and in accordance with a quasi-proportional allocation scheme relative to offer values.

2. The system of claim 1, wherein the computer-based system is an online advertising system, wherein the content providers are advertisers, and wherein the content items are advertisements.

3. The system of claim 1, wherein the quasi-proportional allocation scheme utilizes allocation in accordance with a specified function of the offer values.

4. The system of claim 1, wherein the offer values are based at least in part on the bid information.

5. The system of claim 1, wherein the content items are advertisements, and wherein the offer values are based at least in part on bids and on measures of advertisement quality.

6. The system of claim 1, wherein the content items are advertisements, and wherein the offer values are based at least in part on bids and on measures of combination serving opportunity quality.

7. The system of claim 1, wherein the highest valued subset of the combinations consists of a subset of the combinations that each meets or exceed a threshold offer value.

8. The system of claim 1, wherein the highest valued subset of the combinations consists of a subset of the combinations that is within a highest valued specified fraction, or a specified highest valued quantity, of the plurality of combinations.

9. The system of claim 1, wherein the content items are advertisements, and wherein the online system is an online advertising system, comprising;
a software-based online advertising auction marketplace engine, of the online advertising system, for receiving and storing advertiser bids;
a software-based online advertising allocation engine, of the online advertising system, for generating combinations and for allocation of combinations in accordance with the scheme; and
an online advertising serving engine, of the online advertising system, for serving combinations in accordance with the allocation.

10. The system of claim 1, wherein the content items are advertisements, and wherein an offer value of a combination is determined based on an assessment of predicted performance of the combination as a whole.

11. The system of claim 1, wherein an offer value of a combination is determined based at least in part on an assessment of predicted performance of the combination as a whole, including one or more assessed, predicted or estimated effects of one or more advertisements of the combination on performance of one or more other advertisements of the combination.

12. A method, implemented using one or more server computers, each of the server computers comprising a processor and a memory, the method comprising:
receiving, and storing in memory, a plurality of advertiser bids, for serving of specified advertisements in response to serving opportunities;
determining, and storing in memory, combinations of subsets of the specified advertisements, wherein each of the combinations represents a set of advertisements for potential serving;
allocating a first set of least some of the combinations for serving in response to serving opportunities in accordance with a value-based quasi-proportional allocation scheme relative to determined values of combinations; and
causing serving of combinations of the first set, in accordance the allocation scheme.

13. The method of claim 12, wherein allocating the first set comprises determining the first set as consisting of a subset of the combinations that qualify for allocation and serving in response to serving opportunities.

14. The method of claim 12, comprising determining the values of the combinations, wherein the advertiser bids are in an auction-based online advertising marketplace, and wherein the values are relative to an administrator of the marketplace.

15. The method of claim 12, comprising tracking performance of combinations, and utilizing tracked performance information in assessing values of new combinations.

16. The method of claim 12, wherein the quasi-proportional allocation scheme comprises allocation in accordance with a specified function of the values.

17. The method of claim 12, wherein the quasi-proportional allocation scheme allows advertising marketplace optimization.

18. A non-transitory computer readable storage medium or media tangibly storing computer program logic capable of being executed by a computer processor, the program logic comprising:
online advertising auction engine logic for, in an auction-based online advertising marketplace, receiving and storing advertiser bids for serving of specified advertisements on Web pages;
online advertising allocation engine logic for:
formulating, and storing in memory, combinations of subsets of the specified advertisements, wherein each of the combinations represents a full and ordered slate of advertisements for potential serving upon display of a Web page;
calculating and assigning to each of the combinations, and storing in memory, an offer value representing a performance value of the combination;
identifying, and storing in memory, a highest valued subset of the combinations for serving in response to serving opportunities; and
allocating combinations of the highest valued subset for serving in accordance with a proportional or quasi-proportional allocation scheme relative to values of combinations; and
online advertising serving engine logic for serving the combinations of the subset in accordance with the allocation scheme.

19. The computer readable storage medium or media of claim 18, wherein online advertising allocation engine logic is used to calculate performance values that are measured at least in part relative to predicted profit for the marketplace operator.

20. The computer readable storage medium or media of claim 18, wherein online advertising allocation engine logic is used to implement the allocation scheme including quasi-proportional allocation in accordance with a specified function of the performance values.
